(19) United States
(12) Patent Application Publication
(10) Pub. No.: US 2003/0230160 A1
(43) Pub. Date: Dec. 18, 2003

(54) Barend mounted twist shifter with integrated brake actuator for bicycle

(75) Inventor: Thomas W. Ritchey, Palo Alto, CA (US)

Correspondence Address: Timothy W. Lohse, Gray Cary Ware & Freidenrich, 1755 Embarcadero Road, Palo Alto, CA, 94303-3340, US

(73) Assignee: RITCHEY DESIGNS, INC., Redwood City, CA (US)

(21) Appl. No.: 10/394,094

(22) Filed: Mar. 19, 2003

Related U.S. Application Data
(60) Provisional application No. 60/367,435, filed on Mar. 20, 2002.

(51) Int. Cl. F16C 1/12

(52) U.S. Cl. 74/501.6

(57) ABSTRACT

A barend mounted twist shifter provides for ergonomic shifting and eventual brake actuation. The barend, which commonly provides an ergonomic hold on position for a bike rider's hands at the peripheral handlebar ends provides for an attaching location for the inventive twist shifter. Consequently, a bike rider may operate the bike's derailleur without taking his hands from the barends. A brake actuator may be combined with the twist shifter. The shifter's spool around which the shifter cable coils, may be positioned in the assembly adjacent the barend's tip. Its minimum diameter is substantially independent from the barend's outside diameter and may be reduced such that the actuation torque on the gripdrum may be lowered as well. The gripdrum and spool may be combined with a ratchet mechanism that may be easily integrated in the shifter's housing adjacent the barend's tip. A thumb perch serves as a release for down shifting.

### PRIORITY CLAIM

The present US Application claims priority to the U.S. Provisional Application for a “Barend Mounted Twist Shifter with Integrated Brake Actuator for Bicycle”, Application No. 60/367,435, filed Mar. 20, 2002, which is hereby incorporated by reference.

### FIELD OF INVENTION

The present invention relates to handlebar-mounted devices with integrated twist shifter and brake actuator.

### BACKGROUND OF INVENTION

A bicycle may feature barends that are mounted at the peripheral ends of a handlebar. Such barends are commonly utilized to provide an ergonomic and comfortable position of the bike rider's hands. Barends conventionally are somewhat perpendicular orientated relative to a protrusion direction of the handlebar. The barends point with their outside diameter and their tips substantially in the steering direction. To the contrary, brake levers and shifters are still centrally placed at the laterally protruding portion of the handlebar close to the bicycle's steering column. Thus, even though barend extensions provide a comfortable grip contact with the handlebar, they have limited utility since hand positions have to be changed every time that braking or shifting is performed. Therefore, a need exists for a device that provides shifting and brake actuation at the barends.

Twist shifters provide a means for transforming a rotating hand motion around the handlebar into a derailleur actuation. Prior art shifting devices are actuated via a gripdrum that is mounted rotatable around the handlebar. A derailleur is commonly remotely actuated from the frontal portion of the bicycle via a pulling cable that is guided in a pulling force opposing fashion in a flexible tubular housing. A performance critical factor of the shifter-cable-derailleur assembly is the amount of cable pull initiated by actuating the gripdrum. In common prior art twist shifters, the gripdrum is rotationally rigidly combined with a spool at which the cable end is attached and around which the cable coils when the gripdrum is rotated.

A derailleur is commonly spring loaded, which is necessary to keep the cable under tension and to perform a downshifting when the shifter cable is released. During up shifting, when the cable is pulled, the spring load of the derailleur and friction in the mechanism needs to be overcome by the operating bike rider. Because of debris that usually accumulates in the joints and sliding parts of the shifter-cable-derailleur assembly, the required cable pull force may increase drastically. To keep the actuating torque at the gripdrum to a minimum, it is desirable to have the spool diameter as small as possible. A miniaturization of the spool diameter is limited by the handlebar's outside diameter, which in turn is defined by strength and stiffness requirements of the handlebar. Attempts have been made in the prior art to overcome this limitation by introducing additional transmission elements in the twist shifter. Unfortunately, additional transmission elements make the twist shifter heavier, less reliable and more costly to fabricate. Hence, there exists a need for a twist shifter that provides a direct cable pull via a spool rotatable connected to a gripdrum that rotates around a profile onto which a bike rider may hold on during bike riding. In addition, the desired minimal diameter of the twist shifter's spool should not be limited by that profile's outside diameter as is the case with prior art twist shifters. The present invention addresses this need.

Twist shifters have to provide a relatively large angular movement range of the gripdrum to accommodate for the ever-increasing number of required gear shifting positions. Unfortunately, a human's wrist has only a limited flexibility. A ratchet mechanism combined with the gripdrum may solve that problem. Unfortunately, in prior art twist shifters, the design space for such ratchet mechanism is significantly compromised by the handlebar around which the twist shifter is assembled. The available design space is further limited in handlebar direction by a common presence of a brake lever clamped onto the handlebar next to the twist shifter. Therefore, there exists a need for a twist shifter that may utilize a ratchet mechanism without limitations imposed by the handlebar and/or an adjacently clamped brake actuator. The present invention addresses this need.

### SUMMARY OF INVENTION

A twist shifter is introduced that is configured for attaching and operating at a barend's tip. In that way, the bike rider may actuate a derailleur of the bicycle without taking his/her hands from the barends. The twist shifter may be combined with a brake actuator to provide brake actuation together with derailleur actuation in an ergonomic fashion.

The barend's tips are conventionally open ended and have to comply with relatively low strength and stiffness requirements. The twist shifter of the present invention takes advantage of this fact in various embodiments. In a preferred embodiment, the twist shifter is clamped on the inside of a hollow barend through the barend's open tip. The spool may thereby rotate around the internal clamping feature, thus making its minimum diameter highly independent from the barend's outside diameter.

In another embodiment, a ratchet mechanism is integrated in the twist shifter with a thumb perch actuated ratchet release. Since the twist shifter design is not hampered by the handlebar protruding all the way through the shifter, the ratchet mechanism may be freely designed adjacent the barend's tip and extending within the outside diameter of the barend.

The twist shifter may be configured to fit onto standardized barends. The twist shifter may be also configured in combination with a barend, which may be fabricated with specific features on its tips that may serve for attaching and/or as functional parts of the twist shifter. The barends themselves may be integral part of a handlebar or may be together with the inventive shifter be an independent unit readily attachable at the peripheral ends of the handlebar.

In accordance with the invention, a shifting device is provided. The shifting device comprises a housing configured for positioning at a tip of a profile and for attaching to said profile and a gripdrum rotatable combined with said housing for a rotatable access of said gripdrum around an outside diameter of said profile during said positioning of said housing, The device further comprises a spool in a functional connection with said gripdrum and rotatable embedded in said housing for pulling a derailleur actuating cable, said spool having a bushing diameter being smaller than said outside diameter.

In accordance with another aspect of the invention, a combined shifting and braking actuator is provided. The combined shifting and braking actuator comprises a shifting device and a brake actuator combined with a housing of the shifting device such that a brake lever is ergonomically accessed by a hand operating the grip drum of the shifting device. The shifting device further comprises a housing configured for positioning at a tip of a profile and for attaching to said profile, a gripdrum rotatable combined with said housing for a rotatable access of said gripdrum around an outside diameter of said profile during said positioning of said housing, and a spool in a functional connection with said gripdrum and rotatable embedded in said housing for pulling a derailleur actuating cable, said spool having a bushing diameter being smaller than said outside diameter.

### BRIEF DESCRIPTION OF THE FIGURES

FIG. 1 shows a shaded view of a bicycle's front portion including a handlebar with peripherally attached barend extensions wherein each barend has a barend mounted twist shifter and brake actuator in accordance with the invention.

FIG. 2 shows a perspective view of a first embodiment of a twist shifter with integrated brake actuator mounted on a tubular section representing a barend extension.

FIG. 3 shows more details of the first embodiment of the invention, without the gripdrum and the tubular section shown, wherein the device is configured for clamping to the inside of the barend extension.

FIG. 4 shows a second perspective view of the inventive device without the gripdrum and tubular section shown wherein an exemplary spool with an integrated spring is visible.

FIG. 5 illustrates a second embodiment of the twist shifter with an integrated brake actuator wherein the barend extension is an integral part of the inventive device.

FIG. 6 shows a further embodiment of the present invention, including a thumb perch that operates as a shifter release of a shifting ratchet.

FIG. 7 shows another embodiment of the twist shifter with integrated brake actuator with an inverted spool direction of the shifter cable.

FIG. 8 shows the second embodiment of the twist shifter with integrated brake actuator together with an inverted spool direction of the shifter cable.

FIG. 9 shows a schematic perspective view of a first exemplary internal shifting mechanism.

FIG. 10 shows a schematic perspective view of a second exemplary internal shifting mechanism.

### DESCRIPTION OF THE INVENTION

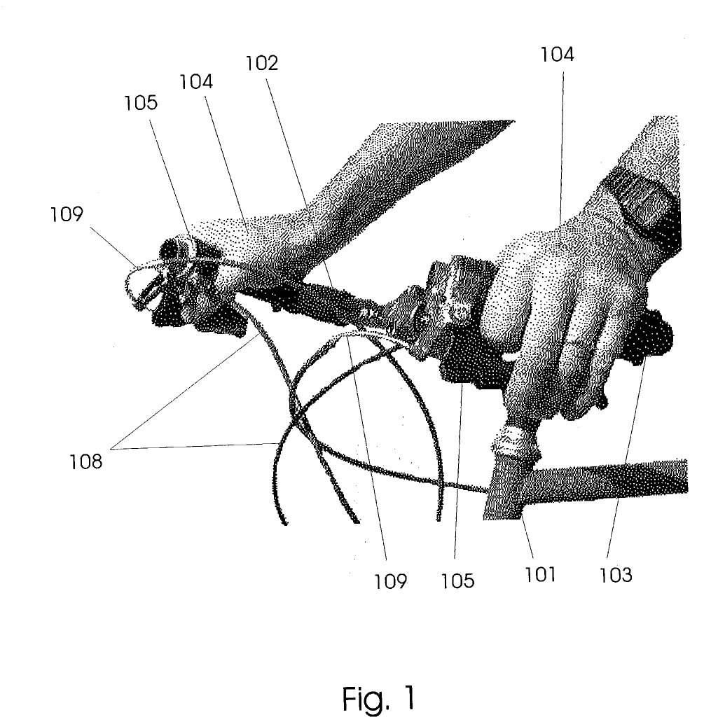

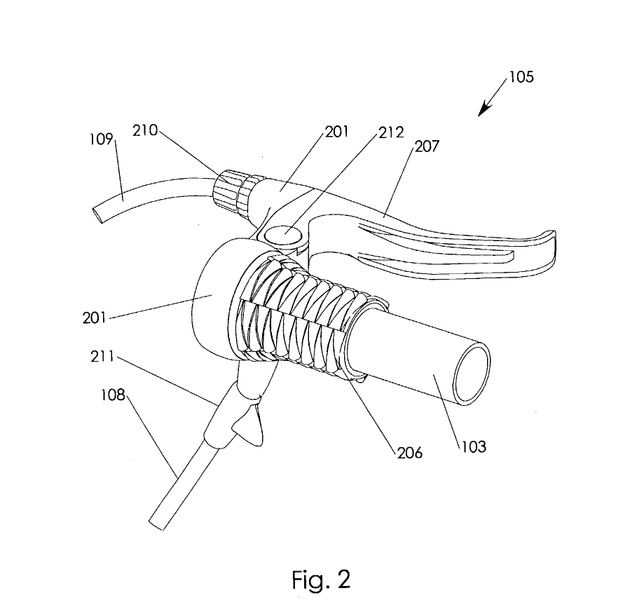

As illustrated in FIG. 1, a bicycle 101 has a well-known handlebar 102 with barends 103 attached on to each end of the handlebar 102 as is well known. The barends 103 may also be an integral part of the handlebar 102. The hands 104 of a person riding the bicycle 101 may rest on the barends 103 as exemplarily depicted in FIG. 1. A device 105, which provide for a preferred combined shifting and brake actuating functions, is placed at each end of the barends 103. Each device 105 may preferably include a rotating gripdrum 206 (see FIGS. 2-8) that provides the shifting function as described below and a brake lever 207 (see FIGS. 2-8) that provides the brake actuation function as described below. The gripdrum 206 and the brake lever 207 are configured and positioned for ergonomic and comfortable access and operation in a hand position as exemplarily depicted in FIG. 1 so that the rider may perform both the shifting operations and brake actuation operations while his/her hands remain on the barends. Cable housings 108, 109 protrude from each of the devices 105 and internally guide cables to a brake (not shown) and a derailleur (not shown) in a well-known fashion.

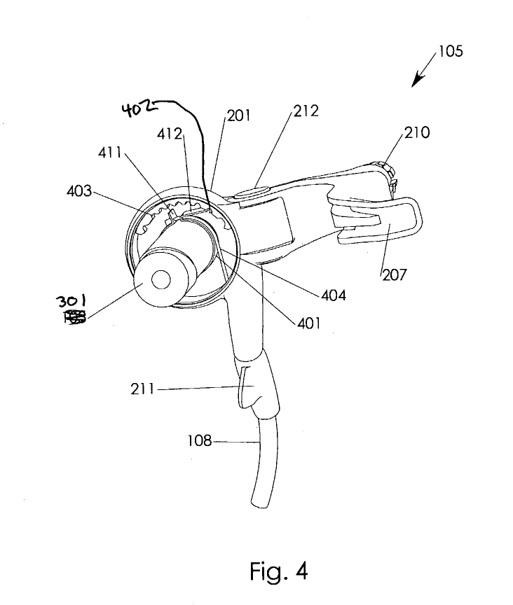

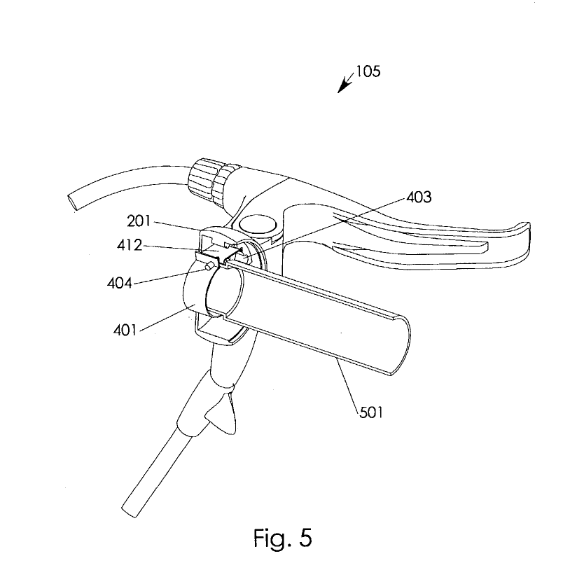

Now referring to FIG. 2, the main components of the device 105 are described. A housing structure 201 is shaped to hold a brake lever 207 that rotates about an axle 212, encapsulate a well known shifting mechanism, retain the ends of the cable housings 108, 109, and guide a shifter cable 404 (see FIGS. 4, 5) and a brake cable (not shown) in a well known fashion towards the cable housings 108, 109. The housing structure 201 may optionally include adjustment screws 210, 211, which are well known for adjusting brake and shifter motion.

The shifting operation is performed by rotating the gripdrum 206 around the barend 103. For that purpose, the barend 103 has a straight cylindrical portion along the length of the gripdrum 206. The cylindrical portion is mainly defined by its outside diameter. The gripdrum 206 is in a functional connection to a cable spool 401, 902, 1002 (see FIGS. 4, 5, 9, 10 below) of an internal shifting mechanism embedded inside the housing structure 201, the inventive aspects of which are described in more detail with reference to FIGS. 4, 5. A functional connection may include a monolithic connection, a snap connection and or a ratchet mechanism as described in more detail below. The integration of the shifting mechanism and the brake actuator inside the housing structure 201 provides for a close positioning of the gripdrum 206 relative to the axle or pivot pin 212 around which the brake lever 207 pivots. As a result, the hands 104 of a rider may be placed close to the pivot pin 212 such that the brake lever 207 is comfortably accessed. The integrated shifter and brake actuator provides additionally for compact and lightweight design. The integrated shifter and brake actuator in accordance with the invention permits a bicycle rider to rest his hands 104 on the barends 103 and operate the bicycle's brakes and derailleur simultaneously.

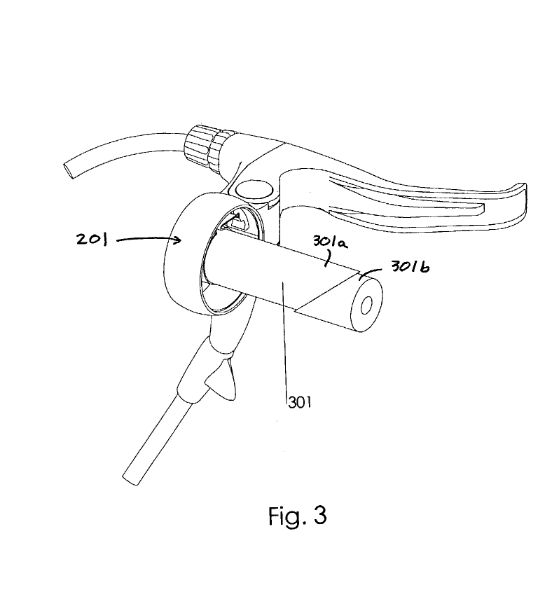

The placement of the device 105 at the end of a barend 103 provides for particular design advantages unattainable with prior art shifting devices mounted at the well-known central portion of the handlebar 102. Firstly, as shown in FIG. 3, the clamping of the device 105 may be accomplished inside of the barend 103. In particular, the housing structure 201 may include an internal clamping mechanism 301 that, for example, transforms an axial force of a screw into a radial clamping force onto an inside diameter of a hollow barend 103 which may be carried out by any clamping mechanism including well known clamping mechanisms. For example, the clamping mechanism 301 may include a first portion 301a and a second portion 301b wherein the tightening of a screw (not shown) offsets the first portion from the second portion as shown which increases the effective diameter of the clamping mechanism. Thus, the device 105 with the internal clamping mechanism 301 is inserted into the barend and then the clamping mechanism 301 is tightened to secure the device 105 onto the barend. In the prior art, twist shifters are commonly clamped on the handlebar's circumference wherein a clamp embedded in the prior art shifter housing typically accomplishes this task. To the contrary, the present clamping mechanism 301 corresponds to the inside contour of the barend 103. Since the clamping feature is put into the inside of the barend 103, the housing structure 201 may be kept at a smaller width and/or scale than prior art shifter devices.

A second particular advantage of the present invention is that the shifting mechanism may be designed without dimensional constraints imposed by the outside diameter of the handle bar 102 and/or the barend 103. These dimensional constraints, such as a particular diameter of the spool, are well-known in prior art twist shifters in which the shifting mechanism is designed to fit around the handlebar 102. In particular, the rotation of the shifter is transmitted on the shifter cable via a well-known spool whereby the shifter cable is attached such that the cable wraps around the spool when the gripdrum is rotated. The diameter of the spool mainly influences the amount of torque that needs to be induced on the gripdrum for performing a shifting operation with a required cable pull force. Thus, a smaller spool diameter requires less torque to be induced on the gripdrum as may be well appreciated by anyone skilled in the art. In prior art cases, where the spool rotates around the handlebar, the diameter of the spool and hence the shifting torque reduction is limited by the handlebar's outside diameter. In the present invention, the device 105 is placed at the end of the barends 103 providing a bushing diameter of a spool 401, 902, 1002 (See FIGS. 4, 9 and 10) that may be smaller than the barend's 103 outside diameter. Preferably, the spool 401, 902, 1002 may rotate around a reduced diameter of the barend 103 or directly around the body of the clamping mechanism 301 as described below in more detail. The body of the clamping mechanism 301 may be accordingly configured with a continuously round shape and/or other well-known features and/or configurations for providing a well known bushing for the spool 401, 902, 1002.

FIG. 4 illustrates a preferred embodiment in which the spool 401 rotates directly around the clamping mechanism 301. In particular, the shifter cable 404 is held with its end and resting on the circumference of the spool 401. When the spool 401 is rotated via the gripdrum 206 in a cable pull direction, the cable 404 wraps around the spool 401 and a pulling force is induced on the cable and transmitted onto a derailleur (not shown). When the spool 401 is rotated via the gripdrum 206 in a cable release direction, the cable 404 uncoils from the spool 401 and the tension of the cable is released and pulled back by the spring loaded derailleur, which then performs a shifting operation in a direction opposite to that during cable pulling. When the device 105 is inserted into a barend and secured into position, the end of the barend abuts the spool 401 so that the spool 401 is able to rotate.

The shifter cable 404 exits the enclosure of the housing structure 201 and is internally guided through the adjustment screw 211 into the cable housing 108 as is well-known for twist shifters. The spool 401 is rotating around the clamping mechanism, which is smaller than the outside diameter of the handlebar 102. As a result, the required shifting torque is lower than in prior twist shifters having a spool rotating around the handlebar 102. The clamping mechanism 301 may feature alignment shoulders (not shown) that position the device 105 on the barends 103 such that sufficient space remains for a free rotation of the spool 401. Moreover, the spool 401 may have an open cross section allowing it to be enlarged in diameter during its assembly. Thus, the portion of the clamping mechanism 301 along which the spool 401 rotates may be further reduced in diameter.

The spool 401 may be fabricated from sheet metal such that a spring feature 402 may be provided together with the spool 401 as a single monolithic structure. The spring feature 402 snaps into a plurality of positioning grooves 403 located within the inner circumference of the housing structure 201. The grooves 403 are positioned in correspondence with required cable pull distances for shifting to different particular gears as is well known and the outer diameter of the spool 401. The spool 401 has a first shoulder 411, which is actuated by a compressive force exerted by the rotated gripdrum 206. The compressive force is exerted on the shoulder 411 during up shifting where the shifter cable is pulled. The spring 402 has a second shoulder 412, which is pressed via a portion of the gripdrum 206 (not shown) during down shifting, during which the shifter cable is released. The second shoulder 412 is placed in a fashion such that the spring 402 is forced out of a groove 403 when the second shoulder 412 is pressed. As a result, the torque required for down shifting has to be merely at a level sufficient to lift the spring 402 out of its groove 403. The spring 402 may be designed to provide a resistive torque against inadvertent down shifting while snapped in one of the grooves 403.

As illustrated in FIG. 5, the scope of the present invention includes embodiments in which a modified barend 501 is specifically configured to operate with the device 105. In particular, since the tip of the barends 103 need to provide relatively little strength and/or stiffness compared to the more central handlebar portions where conventional prior art twist shifters are commonly attached, the tip may be recessed in diameter and/or particularly shaped in a fashion diverging from the main tubular section shape. In that way, the barend tip have a slightly reduced diameter as shown and may fixedly hold the spool 401 and/or may provide a well-known interface for attaching the housing structure 201. The modified barend 501 may be a separate part to be attached on the handlebar 102 or it may be integral part of a correspondingly shaped handlebar 102. In the embodiments with the modified barend, no clamping mechanism 301 may be required.

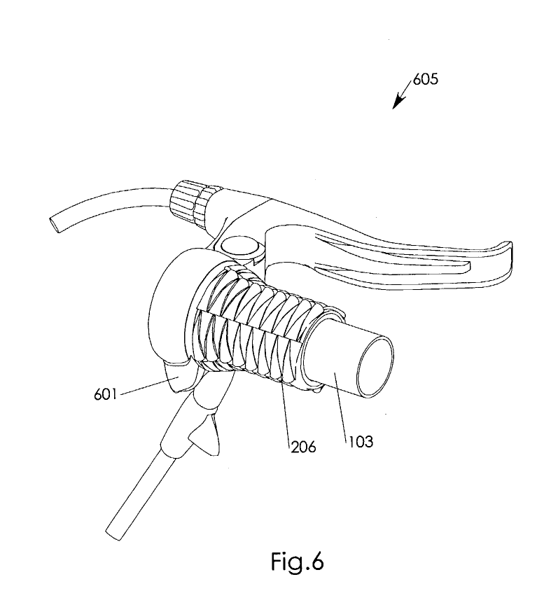

FIG. 6 depicts a second embodiment of the present invention in which a well-known ratchet mechanism is provided. Such a well-known ratchet mechanism includes a first feature for transmitting a torque from a first lever on a modified spool while rotating in a first direction; a second feature for holding the modified spool in its rotational orientation against the cable force, while the first lever is released; and a third feature for releasing the spool in an angular amount that corresponds to a single shifting step of the attached derailleur. The third feature is commonly executed as a second lever. Conventional ratchet mechanisms have a main axis of revolution around which both first and second lever pivot.

In the second embodiment, the position of the device 605 at the tip of the barend 103 may be advantageously utilized for integrating a well-known ratchet mechanism adjacent to the tip of the barend 103. The ratchet's main axis of revolution is thereby preferably brought into an orientation that is substantially concentric to a cylindrical tip of barend 103. The first lever is replaced by the gripdrum 206 and the independently rotating thumb perch 601 replaces the second lever. The ratchet mechanism for converts a repeating back and forth rotation of the gripdrum 206 into a cable pulling rotation of the spool 401, 902, 1002. A one-directional rotation blocking mechanism may block a free rotation of the spool 401, 902, 1002 in the cable releasing direction while allowing for a free rotation of the spool 401, 902, 1002 in the cable pulling direction. A release mechanism may release the blocking of the rotation blocker such that the spool 401, 902, 1002 may rotate into cable releasing direction while the release mechanism is actuated. The thumb perch 601 is part of the release mechanism for ergonomically actuating it by the thumb of the hand operating the shifter 605. The ratchet mechanism may extending within the outside diameter of the barend 103 since it may be placed adjacent the tip of the barend 103.

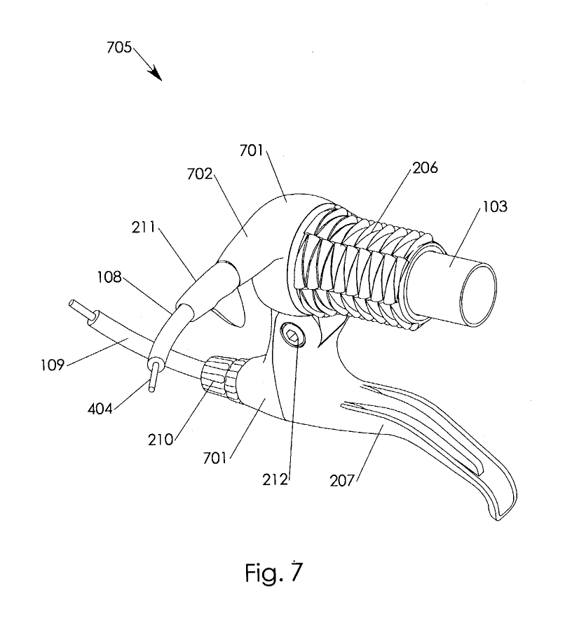

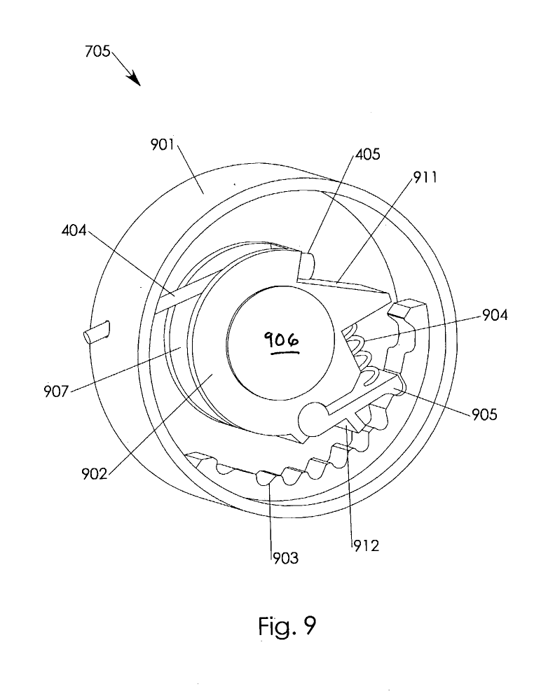

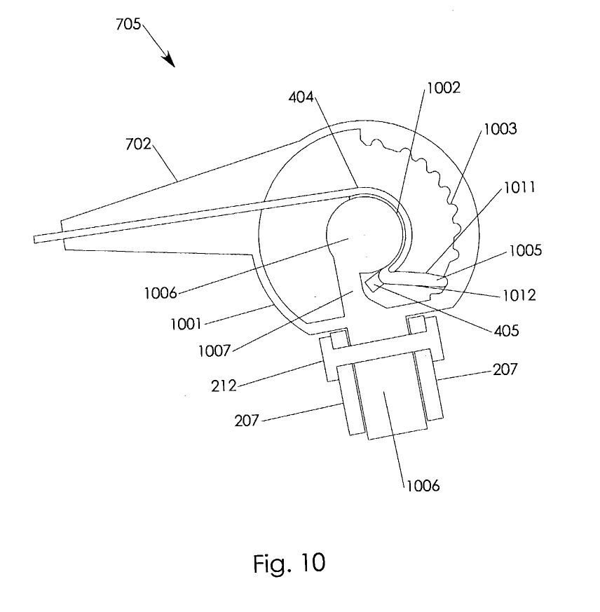

FIGS. 7-10 depict embodiments of the present invention, in which the pull direction of the spool 902, 1002 (see FIGS. 9, 10) is defined in a fashion such that a rotation in the direction of the index finger of a rider results in a pull on the shifter cable 404. This has two advantages in combination with the barend position of the devices 705, 805. First, a housing neck 702, 802 protrudes roughly tangentially and laterally from the upper portion of a cylindrical portion of the housing 701, 801. The cylindrical portion is preferably concentric to the outside diameter of the barend 103. The position of the neck 702, 802 corresponds ergonomically to a groove between the thumb and the index finger of the hands of a rider. As a result, a more reliable holding position on the barends 103 may be maintained, since the neck 702, 802 prevents the hands from accidentally slipping off the barends 103.

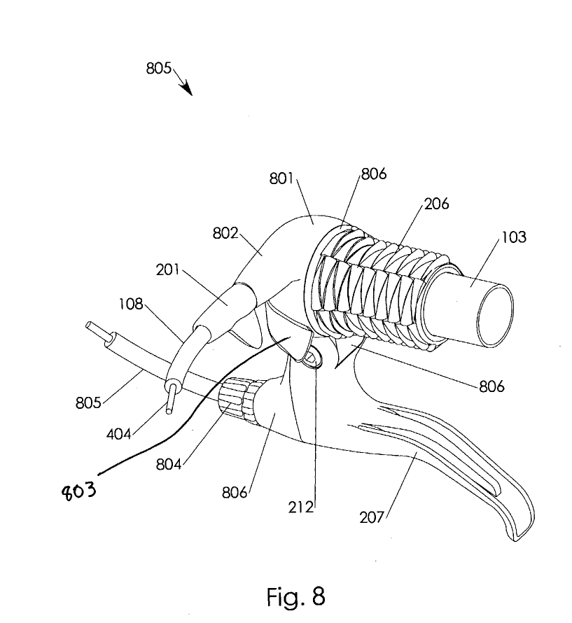

A second advantage is established in combination with a third embodiment of the invention as depicted in FIG. 8. There, an actuator housing 806 is rigidly combined with the gripdrum 206, such that the entire brake actuator, including an actuator housing 806 and a lever 207 rotate together with the gripdrum 206. Thus, the torque necessary to initiate a gear shifting operation may be transmitted thereby from one of the hands onto the gripdrum 206 and/or the brake lever 207. The shifting torque results in a force on the brake lever 207 that is along the pivot axis of the lever 207 defined by the axle 212 such that the brake lever 207 may not be unintentionally moved during shifting. Having an inverted cable pull direction provides for an independently initiated braking and shifting in a substantially unchanged holding position of the hand and fingers on the barend 103.

In the third embodiment, a ratchet mechanism is utilized as described under FIG. 6, such that the brake actuator 207 is rotated only in a relatively small angular range compared to that of the first embodiment with a continuously rotating gripdrum 206. The shifter housing 801 remains rigidly connected to the barend 103. A thumb perch 803 may extend laterally from the shifter housing 801 in a region beneath the neck 802 where it can be pushed by the thumb in a fashion that corresponds to a natural holding position on the barend 103. In order to decouple the rotational movement of the brake actuator 207 from the cable housing 805, a rotating joint may be optionally included in the adjustment screw 804.

FIGS. 9 and 10 schematically illustrate exemplary configurations of some internal shifter components as they may be utilized in the first embodiment of the invention. In FIG. 9, a spool structure 902 rotates around a central portion 906, which may be part of the central fixture 301, or a modified barend 501, or the shifter housing 901. The spool structure 902 has a spool groove 907 into which the shifter cable 404 is positioned while the spool structure 902 is rotated by pressing on the shoulder 911. A substantially rigid pawl 905 hinges in the spool structure 902 and is pushed by an elastic member 904, such as a spring, against the groove profile 903. During up shifting, a pressure is exerted on a shoulder 911 high enough to overcome the preload of the shifter cable 404 and to force the pawl 905 against the elastic member 904 out of a snap position defined by one of the groove profile's 903 grooves. During down shifting, a pressure is exerted on a shoulder 912 of the pawl initiating a rotation of the pawl 905. Once the pawl 905 is rotated out of it's snap position, the spool structure 902 is rotated by the remaining pressure on the shoulder 912 and/or the preload of the shifter cable 404 or is rotated by a dedicated down shifting spring member (not shown).

Since no clamping mechanism needs to be integrated inside the housing 901 and since the diameter of the central portion 906 may be kept relatively small compared to that of a conventional handlebar, all described functional shifter parts 902, 903, 904, 905, 906, 907, 911, 912 may be configured such that the shifter cable 404 is spooling within the height of the groove profile 903 rather than adjacent as commonly practiced in the prior art. The result is a highly compact shifting mechanism and a shifter housing 901 the cylindrical portion of which has an outer diameter of up too less than 40 mm.

FIG. 10 shows another embodiment in which a modified pawl 1005 is combined with a spool structure 1002 into a monolithic structure made from a material that is sufficiently stiff such that the pawl 1005 may operate with sufficient stiffness. The material is also sufficiently elastic such that it can deflect elastically in the interface between pawl 1005 and spool structure 1002 during rotation of the pawl 1005. Such material may be for example a polyethylene. The shifter cable 404 is guided through the interface such that the enlarged cable end 405 holds itself on the opposing end and against the pulling force of the cable 404. The spool structure 1002 has an arc like shape that provides for a simple assembly thereof. The spool structure 1002 wraps sufficiently around the central portion 1006 to snugly contact it in all shifting positions. A shoulder 1011 operates as described for shoulder 911 in FIG. 9. A shoulder 1012 operates as described for shoulder 912 in FIG. 9.

The highly compact design of the spool structure 1002 provides also for a cable spooling within the groove height as described under FIG. 9. In addition, the minimal space consumption of the spool structure 1002 provides sufficient space for other well-known elements of a shifting mechanism within the cylindrical portion of the shifter housing 1001. Such additional elements may be part of a ratchet mechanism as described for the second and third embodiments. Also, a structural element 1007 may be integrated that bridges directly between the central portion 1006 and the housing 1001 of the brake actuator, which assists in optimizing the stiffness of the entire device 705. Further more, the axle 212 may be brought within the outside contour of the barend 103 and into closest proximity to the central portion 1006. This assists additionally in optimizing the geometric arrangement of the hand operated moving parts, such that shifting and braking may by performed in a comfortably and ergonomically optimized while holding on the barends 103.

The scope of the invention includes embodiments, in which the devices 105, 605, 705 or 805 are provided without brake actuator. The scope of the invention includes embodiments, in which the devices 105, 605, 705 or 805 are integral part of a barend readily attachable to the peripheral ends of a handlebar 102. The scope of the invention includes embodiments, in which the devices 105, 605, 705 or 805 are integral part of a modified handle bar having tips and outside diameter of an adjacent cylindrical section pointing substantially into steering direction when mounted on a bicycle 101.

Accordingly, the scope of the invention described in the specification above is set forth by the following claims and their legal equivalent.

What is claimed is:

1. A shifting device comprising:
a) a housing configured for positioning at a tip of a profile and for attaching to said profile;
b) a gripdrum rotatable combined with said housing for a rotatable access of said gripdrum around an outside diameter of said profile during said positioning of said housing; and
c) a spool in a functional connection with said gripdrum and rotatable embedded in said housing for pulling a derailleur actuating cable, said spool having a bushing diameter being smaller than said outside diameter.

2. The shifting device of claim 1, wherein said profile is a barend.

3. The shifting device of claim 1, further comprising a brake actuator combined with said housing such that a brake lever is ergonomically accessed by a hand operating said grip drum.

4. The shifting device of claim 3, wherein a pivot pin around which said brake lever pivots extends within said outside diameter.

5. The shifting device of claim 1, wherein said housing further comprises a clamping mechanism having a clamping diameter for attaching the housing at an inside diameter of said profile.

6. The shifting device of claim 5, wherein said bushing diameter corresponds to said clamping diameter and wherein said spool is rotatable embedded around said clamping mechanism.

7. The shifting device of claim 1, wherein said functional connection includes:
a) a ratchet mechanism for converting a repeating back and forth rotation of said gripdrum into a cable pulling rotation of said spool, said ratchet mechanism extending within said outside diameter;
b) a one-directional rotation blocker for blocking a free rotation of said spool in a cable releasing direction while allowing for a free rotation of said spool in a cable pulling direction; and
c) a release mechanism for releasing said blocking of said rotation blocker such that said spool may rotate into said cable releasing direction while said release mechanism is actuated.

8. The shifting device of claim 7, wherein said release mechanism is actuated by a thumb perch.

9. The shifting device of claim 1, wherein said housing further comprises a housing neck having a position and an orientation that is roughly tangential and laterally protruding from an upper portion of a cylindrical portion of said housing, said position and said orientation ergonomically corresponding to a groove between the thumb and the index finger of a hand operating said shifting device.

10. The shifting device of claim 9, wherein said cylindrical portion is substantially concentric to said outside diameter.

11. A combined shifting and braking actuator comprising:
a) a shifting device including:
i) a housing configured for positioning at a tip of a profile and for attaching to said profile;
ii) a gripdrum rotatable combined with said housing for a rotatable access of said gripdrum around an outside diameter of said profile during said positioning of said housing;
iii) a spool in a functional connection with said gripdrum and rotatable embedded in said housing for pulling a derailleur actuating cable, said spool having a bushing diameter being smaller than said outside diameter; and
b) a brake actuator combined with said housing such that a brake lever is ergonomically accessed by a hand operating said grip drum.

12. The device of claim 11, wherein a pivot pin around which said brake lever pivots extends within said outside diameter.

13. The device of claim 11, wherein said profile is a barend.

14. The device of claim 11, wherein said housing further comprises a clamping mechanism having a clamping diameter for attaching the housing at an inside diameter of said profile.

15. The device of claim 14, wherein said bushing diameter corresponds to said clamping diameter and wherein said spool is rotatable embedded around said clamping mechanism.

16. The device of claim 11, wherein said functional connection includes:
a) a ratchet mechanism for converting a repeating back and forth rotation of said gripdrum into a cable pulling rotation of said spool, said ratchet mechanism extending within said outside diameter;
b) a one-directional rotation blocker for blocking a free rotation of said spool in a cable releasing direction while allowing for a free rotation of said spool in a cable pulling direction; and
c) a release mechanism for releasing said blocking of said rotation blocker such that said spool may rotate into said cable releasing direction while said release mechanism is actuated.

17. The device of claim 16, wherein said release mechanism is actuated by a thumb perch.

18. The device of claim 11, wherein said housing further comprises a housing neck having a position and an orientation that is roughly tangential and laterally protruding from an upper portion of a cylindrical portion of said housing, said position and said orientation ergonomically corresponding to a groove between the thumb and the index finger of a hand operating said shifting device.

19. The device of claim 18, wherein said cylindrical portion is substantially concentric to said outside diameter.

20. The device of claim 11, wherein said profile is a handlebar with said tip and said outside diameter pointing substantially into steering direction.

21. A barend for mounting at the peripheral ends of a handle bar, said barend comprising:
a) a shifting device including:
i) a housing configured for positioning at a tip of said barend and for attaching to said barend;
ii) a gripdrum rotatable combined with said housing for a rotatable access of said gripdrum around an outside diameter of said barend during said positioning of said housing;
iii) a spool in a functional connection with said gripdrum and rotatable embedded in said housing for pulling a derailleur actuating cable, said spool having a bushing diameter being smaller than said outside diameter; and
b) a brake actuator combined with said housing such that a brake lever is ergonomically accessed by a hand operating said grip drum.

22. The barend of claim 21, wherein a pivot pin around which said brake lever pivots extends within said outside diameter.

23. The barend of claim 21, wherein said housing further comprises a clamping mechanism having a clamping diameter for attaching the housing at an inside diameter of said barend.

24. The barend of claim 23, wherein said bushing diameter corresponds to said clamping diameter and wherein said spool is rotatable embedded around said clamping means.

25. The barend of claim 21, wherein said functional connection includes:
a) a ratchet mechanism for converting a repeating back and forth rotation of said gripdrum into a cable pulling rotation of said spool, said ratchet mechanism extending within said outside diameter;
b) a one-directional rotation blocker for blocking a free rotation of said spool in a cable releasing direction while allowing for a free rotation of said spool in a cable pulling direction; and
c) a release mechanism for releasing said blocking of said rotation blocker such that said spool may rotate into said cable releasing direction while said release mechanism is actuated.

26. The barend of claim 25, wherein said release mechanism is actuated by a thumb perch.

27. The barend of claim 21, wherein said housing further comprises a housing neck having a position and an orientation that is roughly tangential and laterally protruding from an upper portion of a cylindrical portion of said housing, said position and said orientation ergonomically corresponding to a groove between the thumb and the index finger of a hand operating said shifting device.

28. The barend of claim 27, wherein said cylindrical portion is substantially concentric to said outside diameter.

29. The barend of claim 21 being integral part of a handlebar.

30. A bicycle comprising a shifting device including:
d) a housing configured for positioning at a tip of a barend and for attaching to said barend;
e) a gripdrum rotatable combined with said housing for a rotatable access of said gripdrum around an outside diameter of said barend during said positioning of said housing; and
f) a spool in a functional connection with said gripdrum and rotatable embedded in said housing for pulling a derailleur actuating cable, said spool having a bushing diameter being smaller than said outside diameter.

31. The bicycle of claim 30, further comprising a brake actuator combined with said housing such that a brake lever is ergonomically accessed by a person operating said bicycle.

32. The bicycle of claim 31, wherein a pivot pin around which said brake lever pivots extends within said outside diameter.

33. The bicycle of claim 30, wherein said housing further comprises a clamping mechanism having a clamping diameter for attaching the housing at an inside diameter of said barend.

34. The bicycle of claim 33, wherein said bushing diameter corresponds to said clamping diameter and wherein said spool is rotatable embedded around said clamping mechanism.

35. The bicycle of claim 30, wherein said functional connection includes:
d) a ratchet mechanism for converting a repeating back and forth rotation of said gripdrum into a cable pulling rotation of said spool, said ratchet mechanism extending within said outside diameter;
e) a one-directional rotation blocker for blocking a free rotation of said spool in a cable releasing direction while allowing for a free rotation of said spool in a cable pulling direction; and
f) a release mechanism for releasing said blocking of said rotation blocker such that said spool may rotate into said cable releasing direction while said release mechanism is actuated.

36. The bicycle of claim 35, wherein said release mechanism is actuated by a thumb perch.

37. The bicycle of claim 30, wherein said housing further comprises a housing neck having a position and an orientation that is roughly tangential and laterally protruding from an upper portion of a cylindrical portion of said housing, said position and said orientation ergonomically corresponding to a groove between the thumb and the index finger of a hand of a person operating said bicycle.

38. The bicycle of claim 37, wherein said cylindrical portion is substantially concentric to said outside diameter.
